(19) United States
(12) Patent Application Publication
(10) Pub. No.: US 2019/0371212 A1
(43) Pub. Date: Dec. 5, 2019

(54) COMPOSITE MOUNTING STRUCTURE FOR A BANNER DISPLAY

(71) Applicant: Daktronics, Inc., Brookings (CN)

(72) Inventors: Kent Shane Miller, Brookings (SD); Ashton Flowers, Shanghai (CN); Mark Bryon Carsrud, Volga (SD); Jon Settingsgard, Brookings (SD)

(21) Appl. No.: 16/477,508

(22) PCT Filed: Jan. 12, 2018
(86) PCT No.: PCT/US2018/013605

§ 371 Date: Jul. 11, 2019

Related U.S. Application Data
(60) Provisional application No. 62/446,179, filed on Jan. 13, 2017.

(51) Int. Cl. G09F 9/302; G09F 15/00; B32B 3/12

(52) U.S. Cl. CPC G09F 9/3026; G09F 9/33; B32B 3/12; G09F 15/0006

(57) ABSTRACT

A display (10) comprises a mounting structure (20) comprising one or more composite members (22) having a first face and a second face, a first plurality of display modules (12) mounted to the first face of the one or more composite members and arranged in proximity to form a first display surface, and one or more tension members (24) coupled to the mounting structure, wherein the one or more tension members support the display when the one or more tension members are connected to a support structure.

### CROSS-REFERENCE TO RELATED APPLICATIONS

This application claims priority to U.S. Provisional Application Ser. No. 62/446,179, filed on Jan. 13, 2017, entitled “COMPOSITE MOUNTING STRUCTURE FOR A BANNER DISPLAY,” the disclosure of which is incorporated herein by reference in its entirety.

### BACKGROUND

Displays comprising a plurality of light-emitting elements, or display modules, are used for the display of information. In some applications, such as digital billboards or scoreboards, individual display modules can be connected together and operated collectively to form a larger display. The larger display can be hung from a support structure, such as the ceiling of a building or a support beam, to provide a display with the appearance of an overhanging banner, often referred to as a banner display.

### SUMMARY

A banner display system can in include a plurality display modules that are hung from a support structure with one or more supporting tension members, such as one or more cables or chains. The plurality of display modules are mounted to a mounting structure comprising one or more supporting structures. In an example, each of the one or more supporting structures is a composite member, such as a composite sandwich panel comprising a honeycomb-like core and one or more surface sheets coupled to the core. The composite member can be made to have a relatively low weight that can allow the banner display to be hung from a support structure.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a partially exploded isometric view of an example banner display for the display of visual information.

FIG. 2 is side view of the example banner display of FIG. 1.

FIG. 3 is a partially peeled-away isometric view of an example honeycomb composite sandwich panel that can be used as a mounting structure in a banner display.

FIG. 4 is a cross-sectional side view of the example honeycomb composite sandwich panel of FIG. 3.

### DETAILED DESCRIPTION

In the following Detailed Description, reference is made to the accompanying drawing which form a part hereof. The drawings show, by way of illustration, examples of banner displays and examples of systems for hanging a banner display to a support structure, such as the ceiling of a building or a support beam. The examples are described in sufficient detail to enable those skilled in the art to practice, and it is to be understood that other embodiments can be utilized and that changes can be made without departing from the scope of the present disclosure. Therefore, the following Detailed Description is not to be taken in a limiting sense, and the scope of the present disclosure is defined by the appended claims and their equivalents.

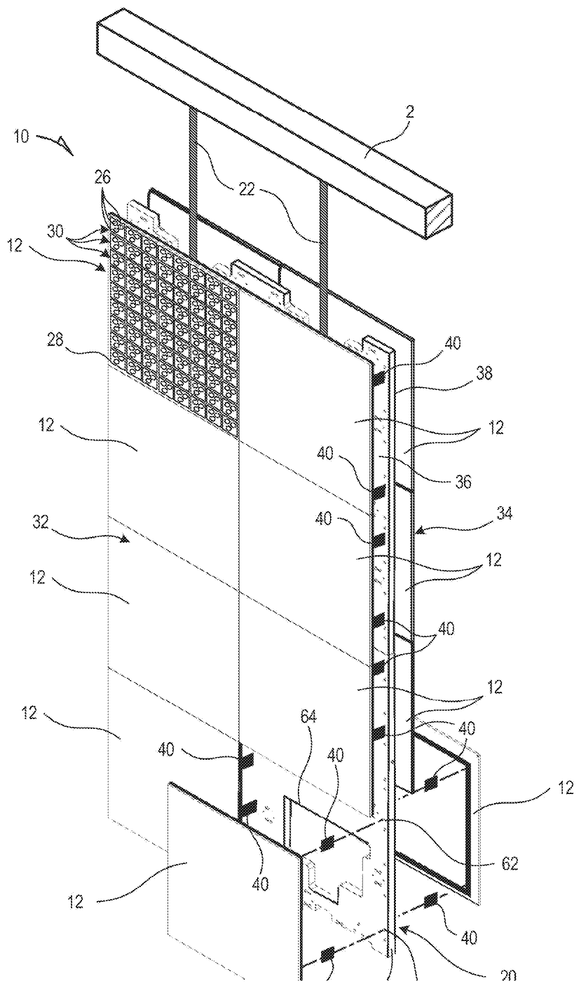

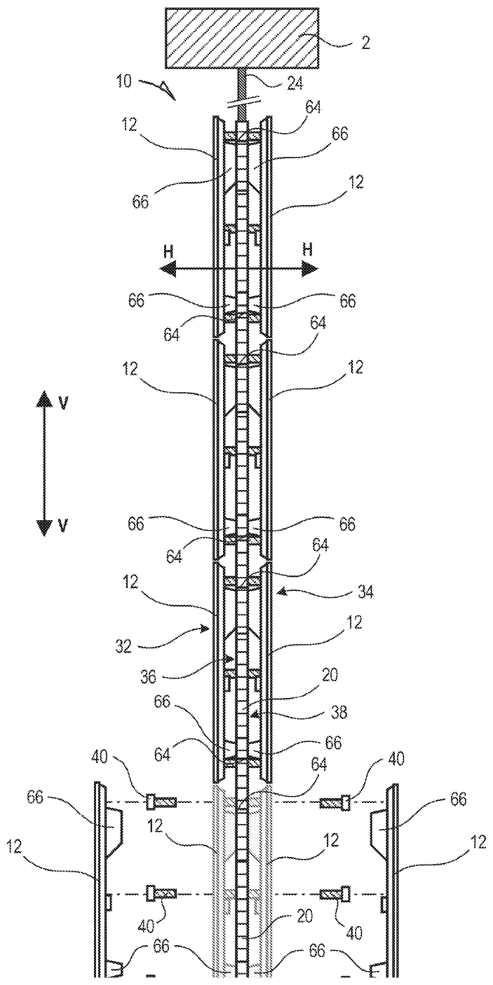

FIGS. 1 and 2 shows several views of an example banner display 10. The banner display 10 is configured to be supported in a hanging manner from a support 2. The support 2 can be, for example, a portion of a ceiling of a building or a support beam. The banner display 10 includes a plurality of display modules 12 that are mounted to and supported by a mounting structure 20. As described in more detail below, the mounting structure 20 comprises one or more structural members 22 that possess sufficient structural integrity to support the plurality of display modules 12.

In an example, the banner display 10 is connected to the support 2 and is hung from the support 2 by one or more tension members 24 that are coupled to the support 2 and to the banner display 10 in order to support the banner display 10 from the support 2. In an example, each tension member 24 is a mechanical structure with a length in a vertical direction (e.g., up and down in FIGS. 1 and 2) that is substantially longer than its width in a horizontal or lateral direction, and that is capable of withstanding a substantial tensile force exerted between the banner display 10 and the support 2. Examples of tension members 24 that might be commonly used to support the banner display 10 to the support 2 include, but are not limited to, cables (such as steel cables), rods (such as metal rebar rods), chains, ropes, beams, or thin metal bars. In some examples, the material that the tension members 24 are made from and the physical shape that the tension members 24 take is not important so long as the tension members 24 can collectively support the banner display 10 and so long as the one or more tension members 24 can be connected to the banner display 10, such as by being connected to the one or more structural members 22. In an example, the tension members 24 comprise cables, such as metal cables, for example steel cables. For this reason, the tension members 24 will be referred to as cables 24 for the remainder of this description. However, a person of ordinary skill in the art will understand that other forms of tension members 24 can be used without varying from the scope of the present invention.

The display modules 12 are configured to display one or more of video, graphical, or textual information. For this reason, the display modules 12 may also be referred to herein as “video display modules” or “graphical display modules” and the banner display 10 may be referred to as a “video display” or a “graphical display.” In an example, each display module 12 includes a plurality of light-emitting elements 26 coupled to a front face 28 of the display module 12. The light-emitting elements 26 are positioned on the front faces 26 of the display modules 12 and the light-emitting elements 26 are operated in such a way so that the display modules 12 display the video, graphical, or textual information to someone who is viewing the banner display 10.

The light-emitting elements 26 can be any type of light-emitting technology known or yet to be discovered for the display of visual information, such as video, graphical, or textual information. At the time of filing of the present application, light-emitting diodes (LEDs) are one of the most common light-emitting technologies in use for video or graphical displays of the type described herein. As such, for the sake of brevity, the light-emitting elements 26 will be referred to as LEDs 26 throughout the present disclosure. However, it will be understood that any time the following description uses the term “light-emitting diode” or “LED,” that light-emitting devices other than LEDs can be used, including, but not limited to, liquid crystal display devices (LCDs), organic light-emitting diodes (OLEDs), organic light-emitting transistors (OLETs), surface-conduction electron-emitter display devices (SEDs), field-emission display devices (FEDs), laser TV quantum dot liquid crystal display devices (QD-LCDs), quantum dot light-emitting diode display devices (QD-LEDs), ferro-liquid display devices (FLDs), and thick-film dielectric electroluminescent devices (TDELs).

In an example, the LEDs 26 are arranged into an array of pixels 30, e.g., with each pixel including one or more LEDs 26 grouped together in close proximity. The LEDs 26 and the pixels 30 are only shown on one display module 12 in FIGS. 1 and 2 and are omitted from the remaining display modules 12 so that other features of the banner display 10 is easier to discern. Also, the sizes of the pixels 30 and the LEDs 26 relative to the overall size of the banner display 10 are not necessarily shown on the scale. However, a person of ordinary skill in the art will understand that all of the display modules 12 that make up the banner display 10 can include pixels 30 of LEDs 26 or that each LED 26 and/or pixel 30 can have a different size relative to the banner display 10.

In an example, multiple LEDs 26 are positioned together at each pixel 30. In some examples, the plurality of LEDs 26 include a plurality of different-colored LEDs 26 such that different-colored LEDs 26 of each pixel 30 can be cooperate to display what appears to be a spectrum of different colors for the viewer of the banner display 10. In an example, each pixel 30 includes a red LED 26, a green LED 26, and a blue LED 26, wherein the red, green, and blue LEDs of each pixel 30 cooperate to provide essentially the entire color spectrum that is visible to humans based on whether one, two, or all three of the LEDs 26 in a pixel 30 are lit and at what intensities. The front face 20 can also provide a black or empty looking surface over a portion of the display, when desired, by deactivating or turning off the LEDs in a particular pixel 30.

In an example, the plurality of display modules 12 are mounted to the mounting structure 20 such that adjacent display modules 12 are in close proximity to one other and the plurality of display modules 12 are operated together in such a way as to display the video, graphical, or textual information in a cohesive manner so that the entire banner display 10 appears to a viewer as a single display that is larger than the individual display modules 12. In an example, the pixels 30 are arranged in a grid-like array, such as a grid comprising a specified number of rows and a specified number of columns of the pixels 30. The banner display 10 can be controlled, for example with control software and/or one or more hardware controllers, so that visual information, e.g., video, graphical, or textual information, is broken down into coordinates. Each coordinate can correspond to a specific pixel location within the overall banner display 10, and the control software and/or the one or more hardware controllers can operate each pixel according to a program that specifies a condition for each coordinate within the image and controls each of the pixels 30 so that it will appear to emit light that meets condition specified. For example, if the banner display 10 is displaying a video or animation, the control software and/or the one or more hardware controllers can be fed the data corresponding to the video or animation, and the control software and/or the one or more hardware controllers can break the video or animation data down into conditions for each pixel 30, such as the time within the video or animation, the color that a pixel 30 is to display at that time and the intensity of the pixel 30 at that time. The control software and/or the one or more hardware controllers can also convert the information regarding color and intensity into specific operating parameters for each LED 26 in a particular pixel 30, such as the power that will be supplied to the red LED 26, the blue LED 26, and the green LED 26 in that pixel 30 and for how long in order to achieve the specified color and intensity at the specified time. The control software and/or the one or more hardware controllers can then send control signals to the pixels 30 or to individual LEDs 26 that can operate the pixels 30 according to the video or animation. Although a grid or grid-like array of LED pixels, as summarized above, is common for video banner displays, the banner display 10 described herein can use other arrangements of the LEDs 26 or other systems for addressing the LEDs 26 can be used without varying from the scope of the present invention.

In an example, the banner display 10 is configured so that visual information can be displayed from more than one side of the banner display 10. The example banner display 10 shown in FIGS. 1 and includes a front display surface 32 on a first, or front, side of the banner display 10 and a rear display surface 34 on a second, or rear, side of the banner display 10. In the example shown in FIGS. 1 and 2, the front display surface 32 and the rear display surface 34 are substantially identical, with the only difference being that the front display surface 32 and the rear display surface 34 are generally facing in opposing directions, Both display surfaces 32, 34 include a plurality of display modules 12 arranged in a close arrangement, as described above, so that LEDs on the front display surface 32 and the rear display surface 34 (such as the LEDs 26 shown in FIG. 1) can be operated together to display visual information on the display surfaces 32, 34.

Because the banner display 10 is being hung from the support 2 by the one or more cables 24, it is advantageous for the overall weight of the banner display 10 to be reduced as much as is possible so that the banner display 10 does not exceed the weight limit that the support 2 or the cables 24 are capable of carrying. For example, in some applications, the banner display 10 is configured to hang from a ceiling of a public place, such as a shopping mall or train station, such that people will be walking under the banner display 10 regularly. For this reason, it is desirable for the manufacturer of the banner display 10 to make each of the components of the banner display 10 to be as light as possible so that the overall weight of the banner display 10 is lower than a typical weight specification for a ceiling structure, and preferably much lower than the weight specification. Some manufacturers have attempted to achieve the goal of reduced weight by removing structures from the support cabinet to which the display modules are mounted. However, the reduced-weight support cabinets tend to have less structural integrity or are less visually appealing. In particular, because the banner displays described in the present disclosure are designed to hang from a support structure, this removal of structures or material from the support cabinet, and the corresponding reduction in structural integrity, can allow gravity to more easily pull the display modules apart, resulting in the formation of undesirable and prominent visual seams.

As noted above, the display modules 12 of the front display surface 32 and the rear display surface 34 are mounted onto the mounting structure 20. The mounting structure 20 of the present disclosure is particularly designed and adapted to allow for a reduced and more optimized weight for the banner display 10 while still providing sufficient structural integrity to support the display modules 12 and minimize the appearance of visual seams in the display surfaces 32, 34.

As is also noted above, the mounting structure 20 includes one or more structural members 22 for supporting the display modules 12. The one or more structural members 22 provide one or more structures for the display modules 12 to be mounted to and one or more structures for connection to the one or more cables 24. In some examples, the support structure 20 comprises a single structural member 22 that provides one or more connection points for each of the display modules 12 in the banner display 10 and one or more connection points for each cable 24. For example, the display modules 12 of the front display surface 32 can be mounted onto a first, or front face 34 of the structural member 22 (or onto the front faces 34 if there are a plurality of structural members 22), while the display modules 12 of the rear display surface 34 can be mounted onto a second, or rear, face 36 of the structural member 22 (or onto the front faces 36 if there are a plurality of structural members 22). In an example, the display modules 12 are mounted to the one or more structural members 22 with a plurality of fasteners 40, such as a first set of fasteners 40 that mount each of the display modules 12 on the front display surface 32 and a second set of fasteners 40 that mount each of the display modules 12 on the rear display surface 34. The fasteners 40 can be spaced at regular intervals and positioned at specified positions relative to the mounting structure 20 and the display modules 12 to provide substantially uniform support of each of the display modules 12 of the banner display 10.

In the example shown in FIG. 1, the fasteners 40 are pins or threaded rods that connect the display modules 12 to the mounting structure 20. In the example shown in FIG. 2, the fasteners 40 are bolts or screws that engage a corresponding threaded feature of the mounting structure 20, the display module 12, or both. Other forms of fasteners can be used without varying from the scope of the present invention, such as stables, nails, brads, or any other fastener capable of coupling a display module 12 to the mounting structure 20 (either permanently, semi-permanently, or temporarily). In other examples, a “fastener,” as that term is conventionally understood, may not be used at all. For example, the display modules 12 can be coupled to the mounting structure 20 by welding, adhering with an adhesive, clamping, or otherwise connecting the display modules 12 to the mounting structure 20.

In an example, the one or more structural members 22 are made from relatively light-weight materials, or that have a relatively low profile, or both. As used herein, the term “low profile,” when referring to the mounting structure 20, can refer to the mounting structure 20 have a relatively small size, especially compared to more conventional support cabinet that are made from a frame onto which display modules are mounted. For example, as shown in FIGS. 1 and 2, the mounting structure 20 (and, therefore, each of the one or more structural members 22 that form it) can be a substantially planar mounting structure 20 with a relatively small thickness T, for example a thickness T of about 2.5 inches or less (e.g., about 6.5 centimeters (cm) or less), such as about 2 inches or less (e.g., about 5 cm or less), for example about 1.5 inches (e.g., about 4 cm or less), such as about 1 inch or less (e.g., about 2.5 cm or less); for example about 0.75 inches or less (e.g., about 2 cm or less); and in some examples as little as 0.5 inches or less (e.g., as little as 1.25 cm or less). While the mounting structure 20 and each of the one or more structural members 22 are made from a relatively light-weight material, or have a relatively low profile, or both, in some examples, they still provide one or more of: sufficient mechanical strength (i.e., tension strength, compression strength, or both) to support the display modules 12; sufficient durability to last during the specified life span of the banner display 10; and sufficient so that the mounting structure 20 does not deform during use of the banner display 10. One relatively light-weight material that may be advantageously used as the one or more structural members 22 of the mounting structure 20 is aluminum.

In an example, each of the one or more structural members 22 is made from a composite material that is constructed to provide for one or more of these material properties. As used herein, the term “composite material” can refer to a structure that comprising more than one component that work together to provide for one or more improved properties of the overall composite material compared to the same one or more properties in each of the components that make up the composite material. As used herein, the term “components,” when referring to a components of a composite material, can refer to different materials or different types of materials that are combined to form the composite material or can refer to different physical structures that might be made of the same material or type of material and are combined in close physical proximity to form the composite material. In some examples, the components of the composite material can cooperate in a synergistic manner. For example, a first component of the composite material can possess one or more desired first properties (e.g., a desired value for one or more first mechanical properties) and a second component of the composite material can possess one or more desired second properties (e.g., a desired value for one or more second mechanical properties). But, by itself, the first component might not possess a sufficient value with respect to the one or more second properties (e.g., the first component might have too high or too low of a value with respect to a second mechanical property). Similarly, by itself, the second component might not possess a sufficient value with respect to the one or more first properties (e.g., the second component might have too high or too low of a value with respect to a first mechanical property). In some examples, however, when the first component and the second component are combined, the resulting composite material can have values of the one or more first properties that are acceptable because of the presence of the first component (even though the second component, by itself, does not) and can have values of the one or more second properties that are acceptable because of the presence of the second component (even though the first component, by itself, does not). In this way, the components of the composite material can, in some examples, contribute to the overall composite material being within a desired specification with respect to several specific properties (such as two or more mechanical properties).

Because the one or more structural members 22 are, in some examples, made from a composite material, the one or more structural members 22 of the mounting structure 20 will also be referred to herein as one or more “composite members 22.” It will be understood that in instances where a structure is referred to as a “composite member” (whether referring specifically to the composite members 22 or to another composite member) that it may be possible in other embodiments to use a structural member that is not made from a composite material without varying from the scope of the present invention.

In some examples, the components that make up a composite member 22 are made from one or more light-weight materials that are structurally configured so that, overall, the composite member 22 will possess sufficient tensile strength in the vertical direction V (FIG. 2) to support the weight of the banner display 10 because the weight of the banner display 10, and in particular the display modules 12, will be pulled by gravity in the vertical direction V. The components that make up the composite member 22 can also be selected and structurally configured to provide sufficient strength in a horizontal direction H (FIG. 2) so that the composite member 22 can hold at least a portion of the weight of a display module 12 at an individual point on the composite member 22 without breaking down so that a display module 12 that is mounted to the composite member 22 will not pull away from the composite member 22. In some examples, the components that make up the composite member 22 can also be selected and structurally configured to provide sufficient rigidity to the composite member 22 and the overall mounting structure 20 (if it is made from a plurality of composite members 22). As used herein, the term “rigidity” refers to resistance to bending or buckling by the composite member 22 and the overall mounting structure 20, and in particular resistance to any portion of the mounting structure 20 being moved out of alignment with the desired vertical or substantially vertical orientation of the banner display 10. As will be appreciated by a person of skill in the art, a structurally supporting member like the one or more composite members 22 of the mounting structure 20 can be subjected to bending or buckling due to non-uniform application of force on the supporting member. For example, force is exerted on the mounting structure 20 in the banner display 10 at the connection point between each of the one or more cables 24 and the mounting structure 20 (which acts vertically upward to counter the gravitational force exerted on the banner display 10), and at each connection point where each of the display modules 12 are mounted to the mounting structure 20 (which can pull both vertically downward due to the weight of each display module 12 being pulled downward by gravity, but can also have a component acting horizontally outward from the faces 34, 36 of the mounting structure 20). There can also various other relatively small forces exerted on the mounting structure 20, such as small torsional forces exerted on the mounting structure 20 by one or more fasteners that couple the cables 24 or the display modules 12 to the mounting structure 20, such as the fasteners 40. Each of these forces act on the mounting structure 20 at a relatively concentrated point (e.g., at or proximate to a specific connection point) and can act in multiple directions. In some examples, the composite members 22 and the overall mounting structure 20 is, in some examples, sufficiently rigid to resist bending or buckling from these various forces, while still allowing the mounting structure 20 (and the entirety of the banner display 10) to be sufficiently light.

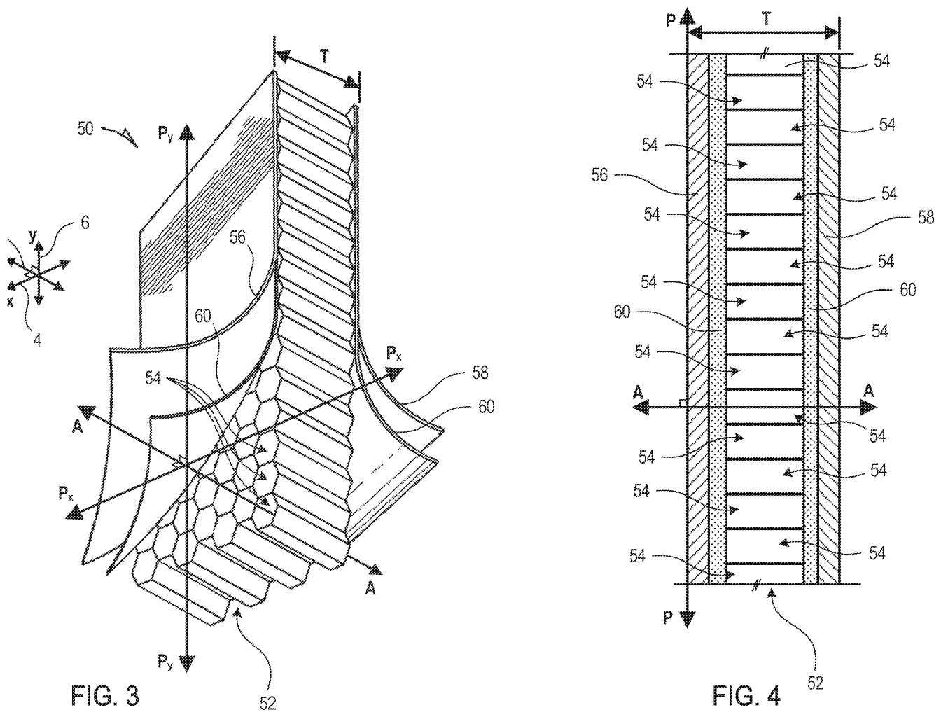

In an example, each of the one or more composite members 22 comprises a sandwich structure or sandwich panel. FIGS. 3 and 4 show an example sandwich panel 50 that can be used to produce the one or more composite members 22 of the mounting structure 20. In an example, the sandwich panel 50 comprises a core 52 that is formed from a plurality of generally cylindrical cells 54. A planar or substantially planar surface sheet is coupled onto each side of the core 52, for example a first surface sheet 56 coupled to a first side of the core 52 and a second surface sheet 58 coupled to a second side of the core 52. In an example, 113 each surface sheet 56, 58 is coupled to the core 52 with an adhesive layer 60 disposed between the core 52 and a corresponding surface sheet 56, 58. However, other methods of coupling the surface sheets 56, 58 to the core 52 can be used, such as fasteners, welding, or clamping. FIG. 3 shows a partially “peeled away” isometric view of the sandwich panel, with a portion of the surface sheets 56, 58 and the adhesive layers 60 peeled away from the core 52 so that details of the cylindrical cells 54 can be seen. It will be understood, however, that in actual use the surface sheets 56, 58 and the adhesive layers 60 will not be peeled away, but rather substantially the entirety of each side of the core 52 is covered with and bonded to a corresponding surface sheet 56, 58, as shown in FIG. 4.

The surface sheets 56, 58 provide surfaces onto which the display modules can be mounted to form the display surfaces. For example, the first surface sheet 56 can provide a first face for mounting display modules that will make up a first display surface (e.g., the front face 36 of the mounting structure 20 for display modules 12 of the front display surface 32) and the second surface sheet 58 can provide a second face for mounting display modules that will make up a second display surface (e.g., the rear face 38 of the mounting structure 20 for display modules 12 of the rear display surface 34). In an example, both the walls that form the cells 54 and the surface sheets 56, 58 are formed from a light and strong material, such as aluminum. In an example, both the walls of the cells 54 and the surface sheets 56, 58 comprise aluminum.

In an example, each of the generally cylindrical cells 54 of the core 52 extend in an axial direction A that is normal or substantially close to be normal relative to the plane P of the overall sandwich panel 50, as shown in FIG. 4. Put another way, the orientation of the sandwich panel 50 can be defined using rectilinear Cartesian coordinates, with the x- and y-directions being defined as the directions in which the planar or substantially planar sandwich panel 50 extends, and the z-direction being defined as the direction of the thickness dimension T of the sandwich panel 50, as demonstrated by the x-axis 4, y-axis 6, and z-axis 8 in FIG. 3. In this way, the plane of the sandwich panel 50 (labeled as plane P in FIG. 4) can be broken down into an x-component that extends in a direction that is parallel to the x-axis 4 (labeled as “Pₓ” in FIG. 3) and a y-component that is parallel to the y-axis 6 (labeled as “P_{y}” in FIG. 3). As shown in FIG. 3, the axial direction A of the cells 54 is perpendicular to both the x-component Pₓ and the y-component P_{y} of the plane of the sandwich panel 50 such that the axial direction A is substantially parallel to the z-axis 8.

In an example, the plurality of cells 54 form a regular geometric pattern that fits together in close proximity. For example, the example cells 54 shown in FIG. 3 each have a cross-sectional shape that is or substantially corresponds to a regular hexagon. The cells 54 can also be positioned so that the till or cover a substantial surface area of the core 52, and in some examples substantially the entirety of the surface area of the core 52. The close-fitting proximity of the plurality of cells and the cells 54 filling or covering a substantial portion of the surface area of the core 52 results in the cells 54 forming an overall pattern that resembles a honeycomb pattern, which is particularly apparent with the hexagonal or substantially hexagonal cells 54 depicted in the example shown in FIG. 3. For this reason, the cylindrical cells 54 may also be referred to as “honeycomb cells 54,” the core 52 that is formed from the honeycomb cells 54 may also be referred to as a “honeycomb core 52,” and the sandwich panel 50 may also be referred to as the “honeycomb sandwich panel 50.” The concept of a honeycomb structure for the cells 54 and the care 52 is not limited to the specific shape or arrangement of the cells 54 depicted in FIGS. 3 and 4. In other words, the honeycomb core 52 is not limited to hexagonal or substantially hexagonal cells 54. Moreover, the honeycomb core 52 is not limited to all the cells 54 being of substantially the same size or all being substantially the same shape. Rather, the cells 54 could have any cross-sectional shape or combination of shapes. As will be appreciated, there can be substantial variation in the shape or shapes of the cells 54, arrangement of the cells 54, and positioning of the cells 54 to form the honeycomb core 52, and that this variation can allow a skilled artisan to tailor the resulting mechanical properties of the honeycomb core 52 and the overall honeycomb sandwich panel 50 to the particular specifications of the banner display, display modules, support, and application.

The honeycomb core 52 and the surface sheets 56, 58 can work together to provide for structural integrity in multiple directions within the honeycomb sandwich panel 50. For example, the honeycomb cells 54 provide for substantial strength in the axial direction A for each of the honeycomb cells 54. As described above, the axial direction A is parallel to the z-axis 8 of the honeycomb sandwich panel 50. The combination of the honeycomb structure of the cells 54 and the arrangement of the cells 54 in close proximity and throughout substantially the entire surface area of the honeycomb care 52 results in the honeycomb sandwich panel 50 having a high rigidity or stiffness in the z-direction. Also, the combination of the honeycomb cells 54 being oriented to be substantially perpendicular to the direction of the plane P of the honeycomb sandwich panel 50, along with the surface sheets 56, 58 being planar or substantially planar in the direction of the plane P results in the plurality of honeycomb cells 54 and the surface sheets 56, 58 providing substantial tensile strength in the x-direction and in the y-direction, which corresponds to the vertical direction V when the honeycomb sandwich panel 50 is used to form the one or more composite members 22 of the mounting structure 20 (see FIG. 2). The substantial tensile strength in the y-direction or the x-direction can also prevent or minimize deformation of the honeycomb sandwich panel 50 in either direction due to gravitational pull, e.g., from gravity acting on the display modules over time, such that the honeycomb sandwich panel 50 can also reduce the likelihood of visual seam formation between adjacent display modules mounted to the honeycomb sandwich panel 50. Moreover, because both the honeycomb core 52 and the surface sheets 56, 58 can be made from a relatively light material, such as aluminum, this high level of rigidity, tensile strength, and minimized deformation can be achieved with a mounting structure that has a weight that is much lower than conventional framed support cabinets, particularly steel support cabinets but which offers better performance than the framed support cabinets.

Returning to FIGS. 2 and 3, in an example where a honeycomb sandwich panel is used to form the one or more composite members 22 of the mounting structure 20, the honeycomb sandwich panel can be a stock honeycomb sandwich structure that is manufactured in bulk by a panel manufacturer. The manufacturer of the banner display 10 can then modify the stock honeycomb sandwich panel, such as by cutting the stock honeycomb sandwich panel to the specified shape, such as the shape of the mounting structure 20 that is best seen in FIG. 1. The stock honeycomb sandwich panel can also be modified by cutting or punching one or more holes through the stock honeycomb sandwich panel, such as one or more fastener holes 62 that each receive and engage with the fasteners 40 or to which a receiving structure can be mounted to the mounting structure 20 wherein the receiving structure can receive and engages with the fastener 40 (such as a nut or nut-like structure that is received or held within a fastener hole 62, where the nut or nut-like structure threadingly engages a bolt-like fastener 40). One or more openings can also be cut into a interior position of the stock honeycomb sandwich panel that will form the mounting structure 20, such as the one or more openings 64 in the mounting structure 20 that are sized and positioned to receive one or more electrical components 66 of a display module 12 (best seen in FIG. 2). The electrical components 66 can be, for example, the supporting electronics for driving or controlling the LEDs 26 of the display modules 12 to display one or more of video, graphical, or textual information on one or more of the display surfaces 32, 34,

As shown in FIGS. 1 and 2, the display modules 12 and their electrical components 66 can be positioned in close proximity to the mounting structure 20. In examples where the one or more composite members 22 that form the mounting structure 20 113 are made from aluminum, this close proximity can allow the mounting structure 20 to act as a heat sink or heat conduit through which heat generated by the electrical components 66 due to operation of the display modules 12 can flow in order to maintain a specified operating temperature for the electrical components 66. As will be appreciated, aluminum is a metal and, therefore, is relatively good at conducting heat. This can also allow an active cooler to be placed somewhere else on or in the banner display 10 and in a position to cool the mounting structure 20, which in turn can cool the electrical components 66 via heat conduction through the mounting structure 20, rather than having to position the cooler proximate to the electrical components 66.

Although the example banner display 10 described, herein is a basic two-sided banner display with generally opposed displays, such as the front display surface 32 and the rear display surface 34 formed from a plurality of the display modules 12 described above, a banner display in accordance with the present disclosure can include other overall geometries, including more or fewer display surfaces than the front and rear display surfaces 32, 34 described above, with one or more of the display surfaces being mounted to a mounting structure comprising one or more composite structures similar or identical to the mounting structure 20 described above. For example, a banner display can include one, three, four, five, or more display surfaces where the display modules of each of the display surfaces of the banner display can be mounted to one or more mounting structures each comprising one or more composite structures similar or identical to the mounting structure 20 comprising one or more composite members 22 (e.g., the honeycomb composite sandwich panel 50).

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A display comprising:
a mounting structure comprising one or more composite members each comprising a composite sandwich panel having a core comprising a plurality of generally cylindrical cells, a first surface sheet coupled to a first side of the core, wherein the first surface sheets of the one or more composite members collectively provide a first mounting face;
a first plurality of display modules mounted to the first mounting face, wherein each of the first plurality of display modules comprises a first plurality of light-emitting elements, wherein the first plurality of light-emitting elements are arranged into a first array of pixels that are operated to display one or more of video, graphic, or textual information, and wherein the first plurality of display modules are arranged in proximity to form a first display surface upon which the one or more of video, graphical, or textual information is displayed; and
one or more tension members coupled to the mounting structure, wherein the one or more tension members support the display when the one or more tension members are connected to a support structure.

2. (canceled)

3. The display of claim 1, wherein the plurality of generally cylindrical cells is arranged in a honeycomb pattern.

4. The display of claim 1, wherein the first surface sheet is planar or substantially planar and wherein each of the generally cylindrical cells are aligned in an axial direction that is normal or substantially normal to the planar or substantially planar first surface sheet.

5. The display of claim 1, wherein the plurality of generally cylindrical cells covers a substantial portion of a surface area of the core.

6. The display of claim 1, wherein the plurality of generally cylindrical cells covers substantially the entirety of a surface area of the core.

7. The display of claim 1, wherein the plurality of generally cylindrical cells of the core and the pair of surface sheets comprise aluminum.

8. The display of claim 1, wherein the composite sandwich panel of each composite member further comprises a second surface sheet coupled to a second side of the core that opposes the first side, and wherein the second surface sheets of the one or more composite members collectively provide a second mounting face opposing the first mounting face, the display further comprising a second plurality of display modules mounted to the second mounting face, wherein each of the second plurality of display modules comprises a second plurality of light-emitting elements, wherein the second plurality of light-emitting elements are arranged into a second array of pixels that are operated to display one or more of video, graphic, or textual information, and wherein the second plurality of display modules are arranged in proximity to form a second display surface upon which the one or more of video, graphical, or textual information is displayed.

9. The display of claim 8, wherein the second display surface is parallel or substantially parallel to and opposing the first display surface.

10. A display comprising:
a planar or substantially planar mounting structure comprising one or more composite members each comprising a composite sandwich panel having a core comprising a plurality of generally cylindrical cells, a planar or substantially planar first surface sheet coupled to a first side of the core and a planar or substantially planar second surface sheet coupled to an opposing second side of the core,
wherein the first surface sheets of the one or more composite members collectively provide a first mounting face, and wherein the second surface sheets of the one or more composite members collectively provide a second mounting face that opposes and is parallel or substantially parallel to the first mounting face;
a first plurality of display modules mounted to the first mounting face, wherein each of the first plurality of display modules comprises a first plurality of light-emitting elements, wherein the first plurality of light-emitting elements are arranged into a first array of pixels that are operated to display one or more of video, graphic, or textual information, and wherein the first plurality of display modules are arranged in proximity to form a first display surface upon which the one or more of video, graphical, or textual information is displayed;
a second plurality of display modules mounted to the second mounting face, wherein each of the second plurality of display modules comprises a second plurality of light-emitting elements, wherein the first plurality of light-emitting elements are arranged into a first array of pixels that are operated to display the one or more of video, graphic, or textual information, and wherein the second plurality of display modules are arranged in proximity to form a second display surface upon which the one or more of video, graphical, or textual information is displayed, wherein the second display surface opposes and is parallel or substantially parallel to the first display surface; and
one or more tension members coupled to the mounting structure, wherein the one or more tension members support the display when the one or more tension members are connected to a support structure.

12. The display of claim 10, wherein the plurality of generally cylindrical cells is arranged in a honeycomb pattern.

13. The display of claim 10, wherein each of the generally cylindrical cells are aligned in an axial direction that is normal or substantially normal to the planar or substantially planar first and second surface sheets.

14. The display of claim 10, wherein the plurality of generally cylindrical cells covers a substantial portion of a surface area of the core.

15. The display of claim 10, wherein the plurality of generally cylindrical cells covers substantially the entirety of a surface area of the core.

16. The display of claim 10, wherein the plurality of generally cylindrical cells of the core and the pair of surface sheets comprise aluminum.
